(19) United States
(12) Patent Application Publication
(10) Pub. No.: US 2008/0274732 A1
(43) Pub. Date: Nov. 6, 2008

(54) Digital Radiocommunication Method and System, Particulary for Mobile Ground Stations

(75) Inventors: Pierre-Henri Boutigny, Melun (FR); Jean-Luc De Gouy, Briis Sous Forges (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 11/722,581

(22) PCT Filed: Oct. 19, 2005
(86) PCT No.: PCT/EP05/55387

§ 371 Date: Apr. 29, 2008

(30) Foreign Application Priority Data
Dec. 23, 2004 (FR) 0413837

(51) Int. Cl. H04Q 7/20

(52) U.S. Cl. 455/427

(57) ABSTRACT

The invention relates to a digital radiocommunication system having an antenna, one or several modems and frequency translators. The system also has at least one device external to the modems connected firstly to at least one modem, and secondly to at least one frequency translator. This device is designed to execute mathematical processing in base band on communication signals output from the modem and/or the translator, for example such as modulation by spectrum spreading of the signal received from the modem; and demodulation by spectrum dispreading of the signal received from frequency translators. Another purpose of the invention is a signal processing method like that used in the system. The invention is applicable to satellite radiocommunication systems onboard mobile ground stations capable of communicating while in movement.

The invention relates to a digital radiocommunication method and system. In particular, the invention is applicable to satellite radiocommunication systems onboard mobile ground stations capable of communicating while in movement.

A satellite connection between two ground stations must firstly satisfy user needs in terms of speed and robustness, and also a number of regulation coordination constraints. These constraints are intended particularly to limit interference between different communication systems.

For fixed or slightly mobile ground stations, the problem at the moment is solved by the use of large antennas, for example antennas with a diameter of more than 1 meter. These antennas can increase the sensitivity in reception while offering a high spatial resolution. However, the use of these large antennas is sometimes a problem for mobile ground stations capable of communicating in movement, for example such as stations onboard vehicles.

A proportion of deployed mobile ground stations is provided with conventional modems that do not manage spectrum spreading and have a small diameter antenna, for example less than 1 meter. These stations cannot set up medium and high-speed data connections and also respect regulation coordination constraints. Furthermore, these stations are sensitive to the Doppler effect, consequently limiting their use to fixed configurations during communication phases.

In particular, the purpose of the invention is to overcome the above-mentioned disadvantages. To achieve this, the purpose of the invention is a digital radiocommunication system comprising an antenna, one or several modems and frequency translators. Furthermore, the system comprises at least one device external to the modems connected firstly to at least one modem, and secondly to at least one frequency translator. This device is designed to execute mathematical processing in base band on communication signals output from the modem and/or the translator, for example such as:
modulation by spectrum spreading of the signal received from the modem,
demodulation by spectrum despreading of the signal received from the frequency translator.

This device may comprise:
a pilot time signal generator generating a pilot time signal for signals to be emitted for which the frequency is chosen outside the useful spectrum of the signal containing information to be emitted;
an adder, that adds the pilot time signal for signals to be emitted to the signal received from the modem;
a pilot time signal generator for received signals for which the frequency is equal to the frequency of the pilot time signal of the signals to be emitted;
a correlation signal generator between the signal originating from the frequency translator, and the pilot time signal of the received signals.

The device may also comprise:
a Doppler correction loop controlled by the correlation signal,
a synchronisation module between demodulation processing by spectrum despreading and the correlation signal.
a frequency control and adaptation unit for the signals emitted and received by said device, the control unit comprising an input from a programming signal.

In particular, the digital radiocommunication system may belong to the ground segment of a system using satellites to relay communication signals. It can set up and maintain communications while in movement. The radiocommunication system may be conditioned:
either as a fixed or mobile ground station,
or as a hub.

Another purpose of the invention is a signal processing method for a digital radiocommunication transceiver used in the digital radiocommunication system.

In particular, the advantage of the invention is that it can provide a spectrum spreading modulation capacity for stations without this capability, without changing modems. Therefore, it is an economic solution. Furthermore, the invention is extendable and configurable, so that it can easily be integrated into an architecture including pendular stations, concentrators and a management segment.

Other characteristics and advantages of the invention will become clear after reading the description below with reference to the appended figures, wherein:

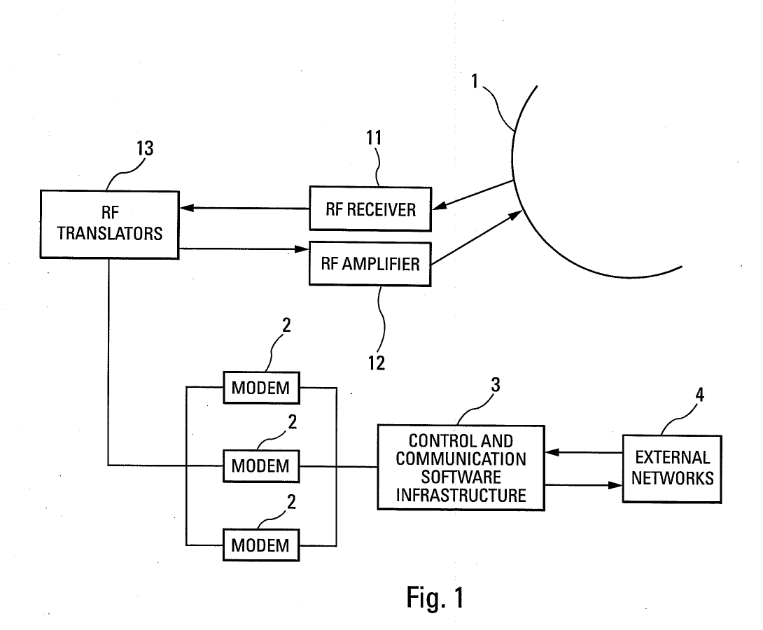

FIG. 1 is a block diagram of a satellite communication system according to the state of the art;

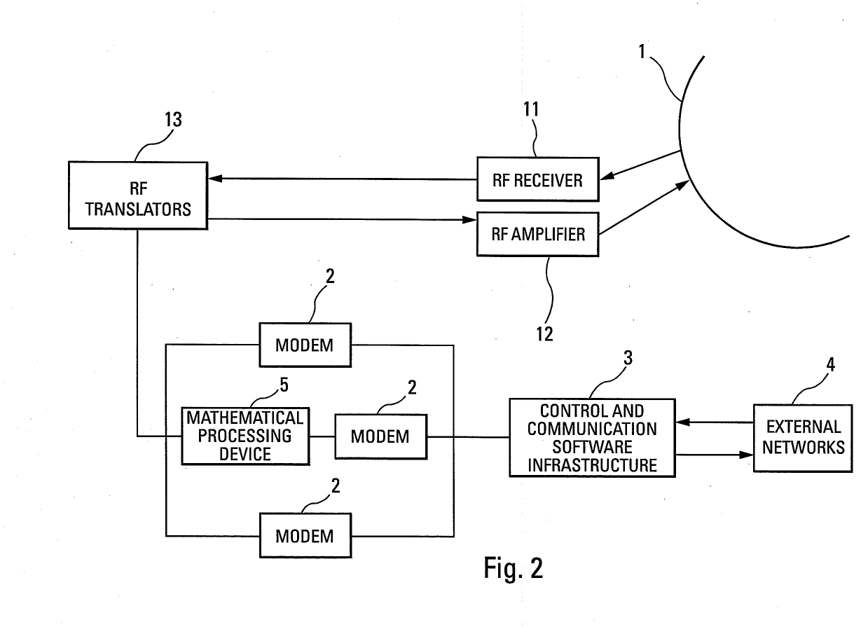

FIG. 2 is a block diagram of a satellite communication system making use of the invention;

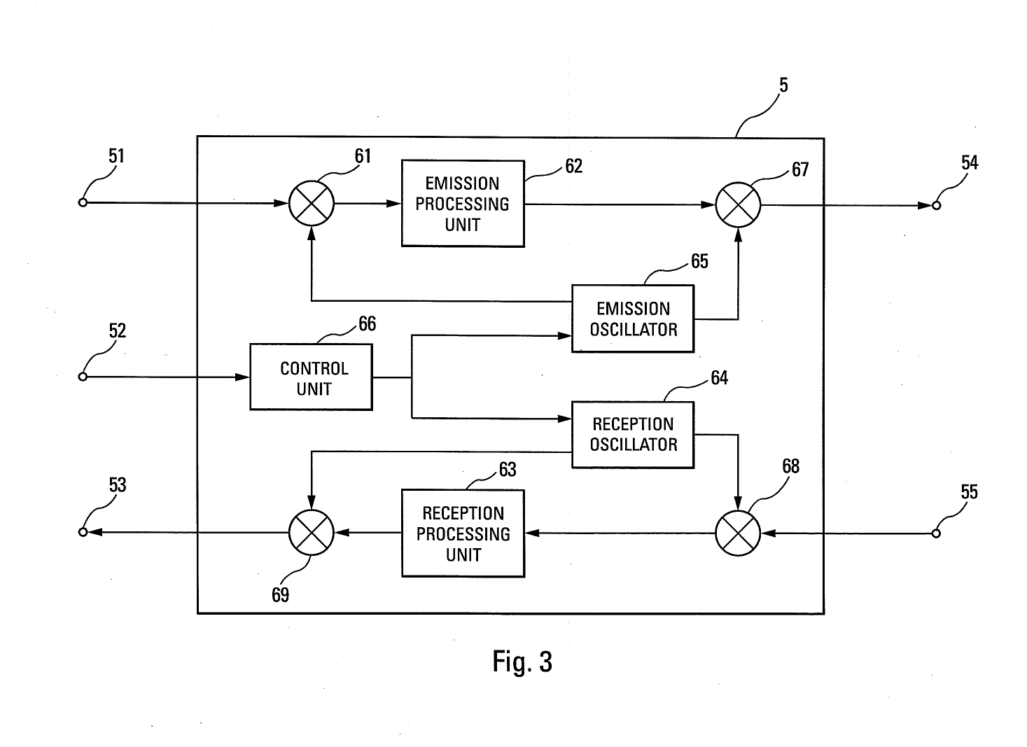

FIG. 3 is a block diagram of the base band processing device;

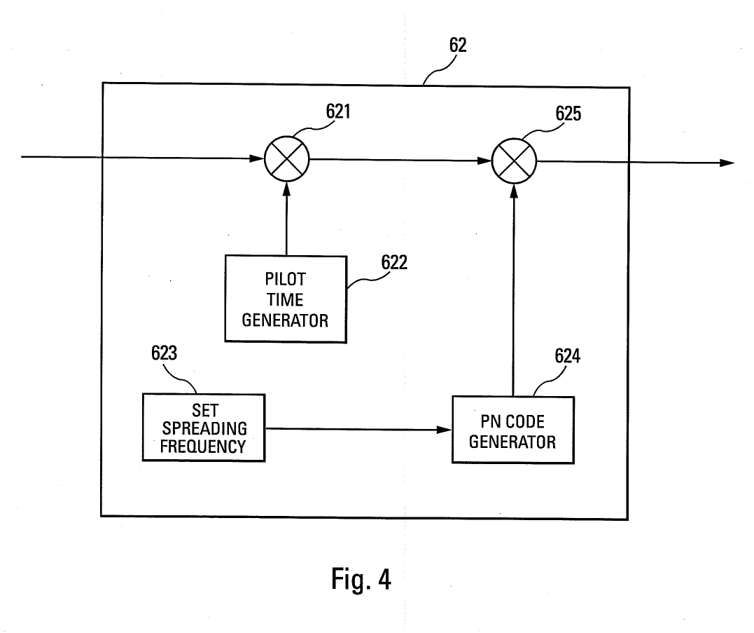

FIG. 4 is a block diagram of the processing unit for signals to be emitted;

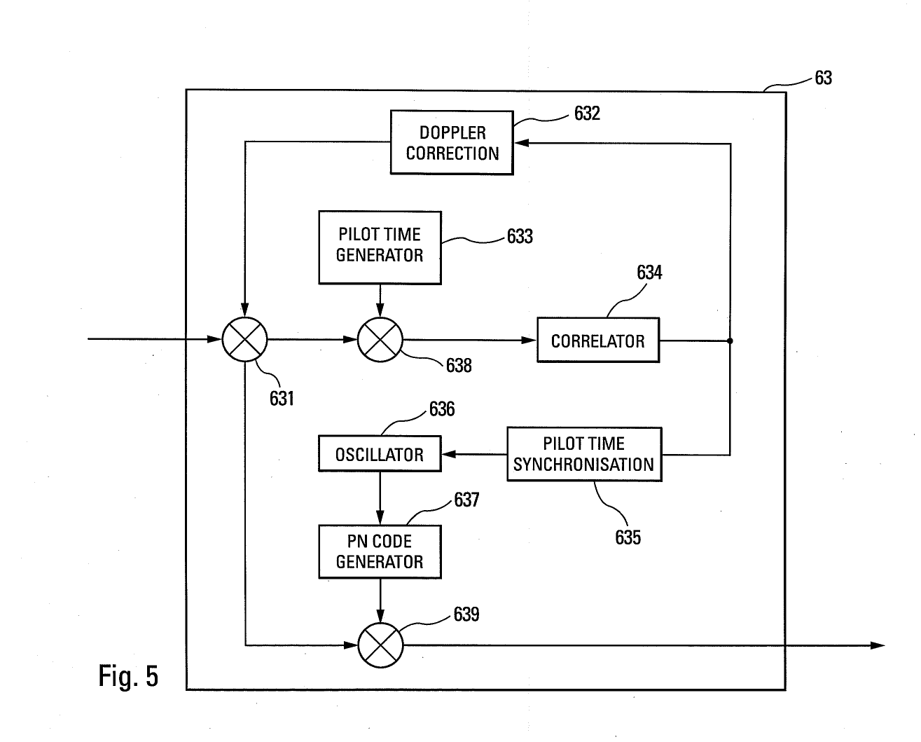

FIG. 5 is a block diagram of the received signals processing unit.

FIG. 1 shows the block diagram for a digital radiocommunication system according to prior art that can be placed onboard a mobile ground station. For example, this system comprises an antenna 1, a radiofrequency receiver 11, a radiofrequency amplifier 12, frequency translators 13, modems 2, a control and communication software infrastructure 3 connected to external data networks 4. In particular, the frequency translators 13 do a frequency transposition:
of the signal received by the antenna 1 at an intermediate frequency called IF, typically between 50 and 90 MHz,
of the signal received from modems 2 at the frequency of the signal to be emitted.
   The modems 2 receive and emit signals at the IF frequency.

FIG. 2 shows the block diagram of a digital radiocommunication system according to the invention. Elements identical to those in FIG. 1 use the same references.

Compared with the system in FIG. 1, there is a mathematical signal-processing device 5 external to the modems 2 arranged between the radiofrequency translators 13 and at least one modem 2. For example, this device is designed to process modulation and demodulation operations by spectrum spreading. Variant embodiments of this device are described below.

FIG. 3 shows a block diagram of the mathematical signal-processing device 5, for example comprising an emission part, a reception part and a control unit 66.

The emission part may for example comprise:
an input 51 receiving an intermediate frequency IF signal emitted by a modem 2,
an output 54 outputting an intermediate frequency IF signal to a radiofrequency translator 13,
an oscillator 65 for signals to be emitted outputting a signal at a given frequency,
a multiplier 61 receiving the intermediate signal IF received from the input 51 and the signal output by the oscillator 65,
a multiplier 67 receiving a signal in base band and the signal output by the oscillator 65, said multiplier outputting an intermediate frequency IF signal to the output 54;
a processing unit 62 for signals to be emitted, receiving a signal in base band from the multiplier 61 and outputting a signal in base band to the multiplier 67.

The processing unit 62 for signals to be emitted receives a signal in base band S_{E}(t) obtained by multiplying the signal received from the input 51 and the signal output by the oscillator 65, this operation being done by the multiplier 61. The signal obtained at the output from the processing unit 62 for signals to be emitted is present on the output 54 after having been transposed into an intermediate frequency IF signal by multiplication (67) by the signal output by the oscillator 65.

For example, the reception part comprises:
an input 55 receiving an intermediate frequency IF signal emitted by a radiofrequency translator 13,
an output 53 outputting an intermediate frequency IF signal to a modem 2,
a received signals oscillator 64, outputting a signal at a given frequency,
a multiplier 68, receiving the intermediate frequency IF signal received from the input 55 and the signal output by the oscillator 64,
a multiplier 69 receiving a base band signal and the signal output by the oscillator 64, said multiplier outputting an intermediate frequency IF signal to the output 53;
a received signal processing unit 63, receiving a base band signal from the multiplier 68 and outputting a base band signal to the multiplier 69.

The received signal processing unit 63 receives a base band signal S_{R}(t) obtained by multiplying the signal received from the input 55 and the signal output by the oscillator 64, this operation being done by a multiplier 68. The signal obtained at the output from the processing unit 63 for signals to be emitted is present on the output 53, after having been transposed into a frequency signal IF by multiplication 69 by the signal output by the oscillator 65.

In particular, the programming and configuration signals include information about the frequency set value of signals in emission and in reception. They are received on the input 52 to which the control unit 66 is connected. For example, these signals may be obtained from an input on a keyboard, from an external programming device or from a control bus for modems 2. The control unit slaves the reception signals oscillator 64 and the emission signals oscillator 65 to the frequencies thus received.

FIG. 4 shows an example of signal processing by spectrum spreading and the addition of a synchronisation signal used by the processing unit 62 for signals to be emitted.

For example, the processing unit 62 for signals to be emitted comprises an adder 621, a pilot time generator 622, an input 623 receiving a set spreading frequency signal F0, a pseudo-random code generator 624 generating a spreading sequence, and a multiplier 625.

A periodic signal called a pilot time signal for signals to be emitted S_{TPE}(t), the frequency of which is chosen outside the useful spectrum of the input signal, is created by the pilot time generator 622, and then added to the signal S_{E}(t) by the adder 621. The power of this periodic signal may be limited so as to maximise the emitted useful signal power, and may for example be less than 10 dB at the useful signal power.

The resulting composite signal is then multiplied at the multiplier 625 by values output from the spreading sequence so as to produce a signal for which the spectrum is for example spread on a frequency band varying by +/−F0. The values derived from the spreading sequence are generated at the rate of the spreading frequency signal FO received from the input 623. This operation spreads the composite signal spectrum on a frequency band varying by +/−F0.

The pilot time signal of signals to be emitted S_{TPE}(t) may be a sinusoidal signal, or any other periodic signal.

FIG. 5 shows an example of signal processing by spectrum despreading and correction of the Doppler effect, said processing being synchronised with a signal present in the received signal and used by the received signals processing unit 63. The received signals processing unit 63 comprises multipliers 631, 638, 639, a Doppler effect corrector 632, a pilot time generator 633, a correlator 634, a synchronisation stage 635, an oscillator 636 and a pseudo-random code generator 637.

The generator 623 generates a periodic signal S_{TPR}(t) called the pilot time signal of the received signals. The frequency of this signal may for example be equal to the frequency of the emissions pilot time signal. The signal S_{R}(t) received by the received signals processing unit 63, including the emissions pilot time signal S_{TPE}(t), is multiplied by the generated periodic signal S_{TPR}(t) transmitted to the correlator 634. The correlator outputs pulses when the signal S_{TPE}(t) included in the signal S_{R}(t) and the pilot time signal S_{TPR}(t) are in phase.

The Doppler corrector 632 then uses the phase of these pulses to generate a Doppler frequency error. This error signal is subtracted by a multiplier 631 from the signal received by the received signals processing unit 63.

The oscillator 636 pilots the frequency at which the pseudo-random code generator 637 presents a new code on its output, and is slaved by the pilot time synchronisation 635 to the position in time of pulses output from the correlator 634. The code sequence thus obtained is multiplied by the corrected Doppler error signal. The resultant signal is presented at the output from the processing unit. This signal is identical to transmission errors and, except the noise on the transmission channel, to the signal received from the input 51, in other words to the signal received from the modem 2 before processings done by the processing unit 62 for signals to be emitted.

1. A digital radiocommunication system, comprising: an antenna,
one or several modems and
frequency translators,
a device, external to the modems, connected firstly to at least one modem, and secondly to at least one frequency translator, said device being designed to execute mathematical processing in base band on communication signals output from the modem and/or the translator.

2. System as claimed in claim 1, wherein said mathematical processings in base band are:
modulation by spectrum spreading of the signal received from the modem;
demodulation by spectrum despreading of the signal received from the frequency translator.

3. System as claimed in claim 1, wherein the device comprises:
a pilot time signal generator generating a pilot time signal for signals to be emitted for which the frequency is chosen outside the useful spectrum of the signal containing information to be emitted;
an adder, that adds the pilot time signal for signals to be emitted to the signal received from the modem;
a pilot time signal generator for received signals for which the frequency is equal to the frequency of the pilot time signal of the signals to be emitted;
a correlation signal generator between the signal originating from the frequency translator, and the pilot time signal of the received signals.

4. The system as claimed in claim 3, wherein the device comprises a Doppler correction loop controlled by the correlation signal.

5. The system as claimed in claim 3, wherein the device comprises a synchronization module between demodulation processing by spectrum despreading and the correlation signal.

6. The system as claimed in claim 1, wherein the device comprises a frequency control and adaptation unit for the signals emitted and received by said device, the control unit comprising an input from a programming signal.

7. Use of the digital radiocommunication system as claimed in claim 1, wherein the radiocommunications system, belonging to the ground segment of a system using satellites to relay communication signals, sets up and maintains communications while in movement, the radiocommunication system being conditioned:
either as a fixed or mobile ground station,
or as a concentrator.

8. A signal processing method for a digital radiocommunication transceiver, wherein the signal is transformed by applying:
a mathematical processing in base band to a signal modulated in intermediate frequency received from at least one modem;
a mathematical processing in base band to a signal translated into intermediate frequency received from a frequency translator.

9. The method as claimed in claim 8, wherein the following mathematical processings in base band are used:
modulation by spectrum spreading of the modulated signal output from the modem;
demodulation by spectrum despreading of the signal received from the frequency translator before its transmission to a modulation step using a modem.

10. The method as claimed in claim 8, performing the following operations:
generation of a pilot time signal for signals to be emitted for which the frequency is chosen outside the useful spectrum of the signal containing information to be emitted;
the addition (621) of the signal received through an input received from the modem and the emissions pilot time signal;
generation of the pilot time signal for received signals for which the frequency is equal to the frequency of the pilot time signal of the emissions;
generation of the correlation signal between the signal received through an input from the frequency translator, and the pilot time signal of the received signals.

11. Method as claimed in claim 10, wherein the signal translated into intermediate frequency received from the frequency translator is slaved to a Doppler correction loop controlled by the correlation signal.

12. The method as claimed in claim 10, wherein demodulation processings by spectrum despreading are synchronised with the correlation signal.
